(19) United States
(12) Patent Application Publication
(10) Pub. No.: US 2007/0126987 A1
(43) Pub. Date: Jun. 7, 2007

(54) Projection system and method for reducing optical noise in projection system

(75) Inventor: Ju-seong Hwang, Cheonan-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/633,573

(22) Filed: Dec. 5, 2006

(30) Foreign Application Priority Data
Dec. 6, 2005 (KR) 2005-0118411

(51) Int. Cl. G03B 21/14

(52) U.S. Cl. 353/20

(57) ABSTRACT

A projection system and method for reducing noise in the projection system are provided comprising a light source unit, an illuminator for collecting light supplied from the light source unit, a diffraction device for receiving light from the illuminator and recognizes an image, a projection lens for projecting the image recognized by the diffraction device, and a screen for displaying the projected image. The light source unit comprises a plurality of light sources for supplying light in different colors, and the illuminator comprises a light synthesizing unit for synthesizing light supplied from the light source unit, a polarization divider for reflecting one polarized light of the synthesized light and transmitting the other polarized light perpendicular to the reflected light, and a phase difference slit disposed between the polarization divider and the diffraction device. Thus, a small-sized projection system is provided which lowers optical noise.

### CROSS-REFERENCE TO RELATED APPLICATIONS

This application claims the benefit under 35 U.S.C. § 119(a) of Korean Patent Application No. 2005-0118411, filed on Dec. 6, 2005, in the Korean Intellectual Property Office, the entire disclosure of which is hereby incorporated by reference.

### BACKGROUND OF THE INVENTION

1. Field of the Invention

The present invention relates to a projection system. More particularly, the present invention relates to a projection system which employs a diffraction device and method for reducing optical noise.

2. Description of the Related Art

Generally, a projection system projects an image created by a display device to a screen to provide a large image. Such a projection system comprises an optical unit having a light source which emits light, an illuminator which collects light emitted by the light source, a display device which creates an image with light supplied by the illuminator, and a projection lens which projects light from the display device to the screen, thereby displaying an image on the screen.

A two-dimensional spatial light modulator employs a digital micromirror device (DMD) or a liquid crystal display (LCD). A diffraction device is used as a spatial light modulator which implements an image as a one-dimensional or linear beam. Here, the diffraction device is embodied by a grating light valve (GLV), a spatial optical modulator (SOM) or a grating electromechanical system (GEMS). Light emitted from the light source is diffracted by the diffraction device through a mirror and transmitted to the projection lens.

The conventional projection system comprises a mirror for each of red, green and blue (RGB) light sources, thereby increasing the size of the system. Also, more time is taken to arrange and adjust optical devices, and the malfunction rate rises.

The diffraction device comprises a cover glass to prevent from being oxidation or contact with an external material. However, the cover glass reflects light which lowers the contrast of the image. When light is diffracted in a direction different from the direction by the diffraction device, optical noise is observed in a form of a spot on the screen.

Accordingly, there is a need for an improved projection system that is small in size and method for reducing optical noise in the projection system.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a small-sized projection system which reduces optical noise.

Additional aspects and/or advantages of exemplary embodiments of the present invention will be set forth in part in the description which follows and, in part, will be obvious from the description, or may be learned by practice of the present invention.

The foregoing and/or other aspects of exemplary embodiments of the present invention are also achieved by providing a projection system comprising a light source unit, an illuminator for collecting light supplied from the light source unit, a diffraction device for receiving light from the illuminator and creates an image, a projection lens for projecting the image created by the diffraction device, and a screen for displaying the projected image. The light source unit comprises a plurality of light sources for supplying light in different colors. The illuminator comprises a light synthesizing unit for synthesizing light supplied from the light source unit, a polarization divider for reflecting one polarized light of the synthesized light and transmitting the other polarized light perpendicular to the reflected light, and a phase difference slit disposed between the polarization divider and the diffraction device.

According to another aspect of exemplary embodiments of the present invention, the phase difference slit comprises a transmission area which corresponds to the diffraction device, and a phase shift area which is disposed next to both sides of the transmission area and changes a phase of light as much as λ/2.

According to another aspect of exemplary embodiments of the present invention, a polarization state of the light is changed by the phase shift area.

According to another aspect of exemplary embodiments of the present invention, a phase contrast slit is combined with the polarization divider.

According to another aspect of exemplary embodiments of the present invention, the projection system further comprises a scanning unit for scanning the light diffracted by the diffraction device and provides the scanned light to the projection lens.

### BRIEF DESCRIPTION OF THE DRAWINGS

The above and other objects, features and advantages of certain exemplary embodiments of the present invention will be apparent from the following description taken in conjunction with the accompanying drawings, in which:

FIG. 1 is a schematic view of a projection system according to an exemplary embodiment of the present invention;

FIG. 2 illustrates a diffraction device according to an exemplary embodiment of the present invention; and

FIG. 3 illustrates a phase contrast slit according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

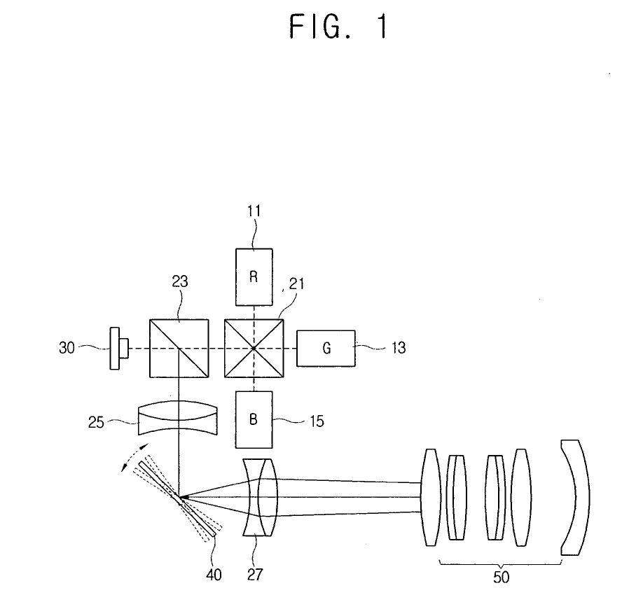

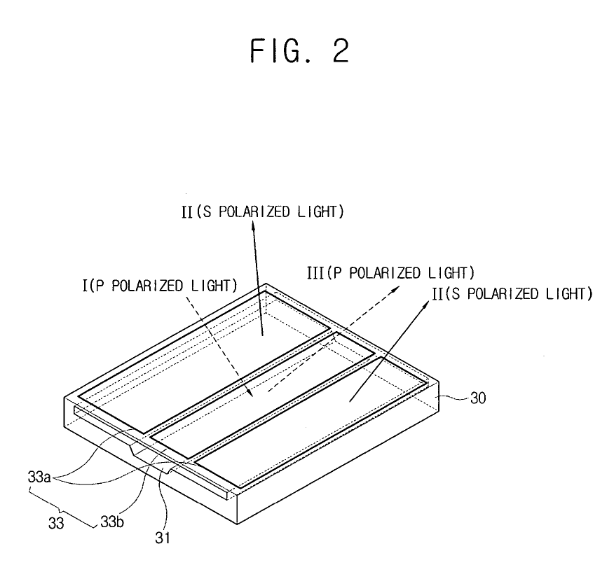

Hereinafter, a projection system according to an exemplary embodiment of the present invention will be described with reference to FIGS. 1 and 2. FIG. 1 is a schematic view of the projection system according to an exemplary embodiment of the present invention. FIG. 2 illustrates a diffraction device having a phase contrast slit, according to an exemplary embodiment of the present invention.

As shown therein, the projection system according to an exemplary embodiment of the present invention comprises a light source unit, an illuminator for collecting light supplied from the light source unit, a diffraction device 30, a scanning unit 40, and a projection lens 50. The light source unit comprises a plurality of light sources 11, 13 and 15. The illuminator comprises a light synthesizing unit 21 and a polarization divider 23. The projection system further comprises a first light collecting lens 25 which is adjacent to an incident surface of the scanning unit 40 to collect diffracted light; a second light collecting lens 27 which collects the scanned light to guide the light to the projection lens 50; and a screen (not shown) which displays light projected by the projection lens 50.

The light sources 11, 13 and 15 provide light in different colors. For example, the light sources 11, 13 and 15 employ a laser which is highly uniform and efficient in light. As a small-sized projection system is provided, for example, the laser used as the light sources 11, 13 and 15 is preferably small.

The light sources 11, 13 and 15 according to an exemplary embodiment of the present invention provide red, green and blue light, but not limited thereto. Alternatively, the light sources 11, 13 and 15 may provide cyan, magenta or yellow light according to the type of display device or an input video signal, instead of red, green and blue light.

The light synthesizing unit 21 mixes light that is emitted from the plurality of light sources 11, 13 and 15. The light synthesizing unit 21 may comprise a cube-type dichroic prism or dichroic filter. Since the projection system according to an exemplary embodiment the present invention comprises the light synthesizing unit 21, a mirror and a prism, which are typically provided in the conventional projection system, may be excluded. That is, the conventional projection system comprises a mirror or a lens to guide the light from the respective light sources to each of the diffraction devices, and a prism array to mix the diffracted red, green and blue light. Meanwhile, in an exemplary implementation, the light emitted from the plurality of light sources 11, 13 and 15 is transmitted to a single diffraction device 30 through the light synthesizing unit 21, thereby contributing to a smaller projection system.

The polarization divider 23 reflects one polarized light having a predetermined light axis and transmits the other polarized light having a light axis perpendicular to the reflected light. That is, the polarization divider 23 transmits vertical linear polarized light (hereinafter to be referred to as P polarized light), and reflects a horizontal linear polarized light (hereinafter, to be called S polarized light).

According to an exemplary embodiment of the present invention, when the polarization divider 23 receives the unpolarized light, the light is first linear-polarized and then divided. To divide light into the polarized lights, the polarization divider 23 comprises a plurality of polarizing beam splitter prisms having a polarization dividing surface which is inclined with respect to both an incident surface and an emitting surface. The incident light is divided into the P polarized light and the S polarized light from the inclined polarization dividing surface of the polarizing beam splitter prisms. Here, the P polarized light is directly emitted while the S polarized light is converted into the P polarized light by a half-wave plate (not shown) partially disposed on the polarization divider 23, to be emitted. The incident light is emitted as a single linear polarized light, that is, the P polarized light by the polarization divider 23. The polarization divider 23 may comprise a wire grid polarizer.

As shown in FIG. 2, the diffraction device 30 comprises a diffraction array 31, which has a stripe shape, and a phase contrast slit 33, which is formed on the diffraction array 31. The phase contrast slit 33 according to an exemplary embodiment of the present invention is integrally provided in a housing with the diffraction array 31. The phase contrast slit 33, for example, may be provided as a part of the housing.

The diffraction array 31 may comprise a grating light valve (GLV), a spatial optical modulator (SOM) or a grating electromechanical system (GEMS). The diffraction array 31 modulates the diffraction efficiency of light according to an electrical image signal supplied from an external source.

The phase contrast slit 33 comprises a transmission area 33b which corresponds to the diffraction array 31, and a phase shift area 33a which is disposed next to both sides of transmission area 33b.

The incident P polarized light “I” is diffracted in a direction perpendicular to a lengthwise direction of the diffraction array 31 having a stripe shape. The diffracted light “II” changes as much as λ/2 in phase with respect to the incident direction while passing through the phase shift area 33a, thereby changing the polarization state from the P polarized light to the S polarized light. The S polarized light is incident to the scanning unit 40 to be supplied to the screen.

The light “III” which is not diffracted and reflected by the phase contrast slit 33 or which is diffracted in a parallel direction of the lengthwise direction of the diffraction array 31 passes through the transmission area 33b, thereby remaining in the original polarization state, that is, remaining in the P polarized light and transmitted to the polarization divider 23.

Accordingly, the light having the polarization state needed in the projection system is incident to the scanning unit 40. The P polarized light diffracted into the S polarized light, or the reflected P polarized light returns to the polarization divider 23.

The scanning unit 40 scans the light incident as a linear type by the diffraction device 30 in leftward and rightward directions to supply the light to the projection lens 50. The diffraction device 30 according to an exemplary embodiment of the present invention comprises a linear spatial light modulator, which requires an optical device that scans light to display an image on a two-dimensional screen.

The scanning unit 40 may comprise a galvano mirror, but not limited thereto. Alternatively, the scanning unit 40 may be variously provided as long as it scans a linear image in leftward and rightward directions and recognizes the two-dimensional image.

The first and second light collecting lenses 25 and 27 collect the incident light to enhance the light efficiency and guide light to a desired place. The light collecting lenses 25 and 27 may comprise a convex lens, an object lens or an ocular lens, but not limited thereto. The light collecting lenses 25 and 27 may further comprise a collimator to collimate the incident light as the parallel light between the respective optical devices.

The projection lens 50 may comprise a plurality of lenses to project the image recognized by the diffraction device 30 to the screen. The projection lens 50 comprises various lenses having a circular or non-circular shape, and includes lenses having different focal distances and a radius to correct color differences and aberrations.

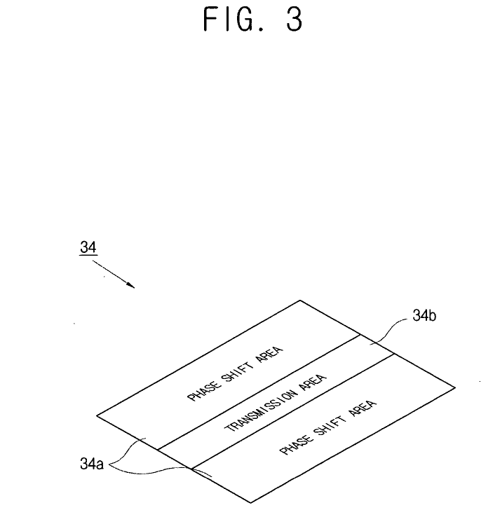

FIG. 3 illustrates a phase contrast slit according to an exemplary embodiment of the present invention. The phase contrast slit 34 has a plate shape separately, instead of being formed as a single body with the diffraction device 30.

The phase contrast slit 34 according to an exemplary embodiment of the present invention comprises a transmission area 34b which corresponds to a diffraction array, and a phase retardation area 34a which is disposed next to both sides of the transmission area 34b. The P polarized light which is incident from the diffraction array changes as much as λ/2 in phase in the phase shift area 34a, thereby changing the polarization state to the S polarized light. The light which passes through the transmission area 34b remains in the P polarized light and is transmitted to the polarization divider.

The phase contrast slit 34 may be independently provided between the diffraction device and the polarization divider, or attached to the polarization divider. The angle between the light incident to the diffraction device and the diffracted light is 3°-5°, which is very small. Thus, light which should pass through the phase shift area 34a can be supplied to the transmission area 34b, thereby unnecessarily creating noise. The phase contrast slit 34 may be disposed in a position adjacent to the polarization divider, or preferably on a surface of the polarization divider to prevent such optical noise and enhance the light efficiency.

The projection system according to the exemplary embodiments of the present invention mixes light from the plurality of light sources 11, 13 and 15 through a single light synthesizing unit 21, and scans the diffracted light which is selectively polarized through the phase contrast slit 33 and 34, thereby recognizing the image. With such a configuration, the optical noise decreases and the small-sized projection system is implemented.

As described above, the exemplary embodiments of the present invention provides a small-sized projection system which reduces optical noise.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A projection system comprising:
a light source unit;
an illuminator for collecting light supplied from the light source unit;
a diffraction device for receiving light from the illuminator and recognizing an image;
a projection lens for projecting the image recognized by the diffraction device; and
a screen for displaying the projected image,
wherein the illuminator comprises a light synthesizing unit for synthesizing light supplied from the light source unit, a polarization divider for reflecting at least one polarized light of the synthesized light and transmitting a remaining polarized light perpendicular to the reflected light, and the diffraction device comprises a diffraction array, a phase difference slit disposed between the polarization divider and the diffraction device.

2. The projection system of claim 1, wherein the light source unit comprises a plurality of light sources for supplying light in different colors.

3. The projection system according to claim 1, wherein the phase difference slit comprises a transmission area corresponding to the diffraction device, and a phase shift area disposed next to both sides of the transmission area and changes a phase of light as much as λ/2.

4. The projection system according to claim 3, wherein the light comprises a polarization state that is changed by the phase shift area.

5. The projection system according to claim 1, wherein the phase difference slit is combined with the polarization divider.

6. The projection system according to claim 1, further comprising a scanning unit for scanning the light diffracted by the diffraction device and providing the scanned light to the projection lens.

7. A method for reducing optical noise in a projection system, the method comprising:
collecting light supplied from a light source unit;
synthesizing light supplied from the light source unit;
reflecting at least one polarized light of the synthesized light and transmitting a remaining polarized light perpendicular to the reflected light;
scanning the light diffracted by a diffraction device and providing the scanned light to a projection lens;
projecting the image recognized by the diffraction device; and
displaying the projected image.

8. A means for reducing optical noise in a projection system comprising:
means for collecting light supplied from a light source unit;
means for synthesizing light supplied from the light source unit;
means for reflecting at least one polarized light of the synthesized light and transmitting a remaining polarized light perpendicular to the reflected light;
means for diffracting the transmitted light;
means for scanning the diffracted light and providing the scanned light to a projection lens;
means for projecting the image recognized by the diffraction device; and
means for displaying the projected image.
